(19) United States
(12) Patent Application Publication
(10) Pub. No.: US 2025/0039387 A1
(43) Pub. Date: Jan. 30, 2025

(54) TEMPORAL RESAMPLING AND RESTORATION IN VIDEO CODING AND DECODING SYSTEMS

(71) Applicant: Tencent America LLC, Palo Alto, CA (US)

(72) Inventors: Shan LIU, San Jose, CA (US); Ding DING, Palo Alto, CA (US)

(73) Assignee: Tencent America LLC, Palo Alto, CA (US)

(21) Appl. No.: 18/676,147

(22) Filed: May 28, 2024

Related U.S. Application Data
(60) Provisional application No. 63/529,751, filed on Jul. 30, 2023.
(60) Provisional application No. 63/539,069, filed on Sep. 18, 2023.

(51) Int. Cl. H04N 19/132; H04N 19/176; H04N 19/70

(52) U.S. Cl. CPC H04N 19/132; H04N 19/176; H04N 19/70

(57) ABSTRACT

This disclosure relates generally to video coding/decoding and particularly for signaling in temporal resampling and restoration in video coding and/or decoding systems. One method includes receiving the coded video bitstream; extracting, from the coded video bitstream, a syntax indicating a temporal restoration mode, wherein the syntax comprises: a flag and an index, the flag indicating whether temporal restoration is enabled, the index indicating one temporal resampling ratio out of 2\hat{ }N non-unity temporal resampling ratios, wherein the index has N bits, or an index only, the index indicating whether the temporal restoration is enabled and one temporal resampling ratio of at least one temporal resampling ratios; and when the temporal restoration is enabled, restoring, by the device, reconstructed frames to obtain restored frames based on the indicated temporal resampling ratio.

### INCORPORATION BY REFERENCE

This application is based on and claims the benefit of priority to U.S. Provisional Application No. 63/529,751, filed on Jul. 30, 2023, which is herein incorporated by reference in its entirety. This application is also based on and claims the benefit of priority to U.S. Provisional Application No. 63/539,069, filed on Sep. 18, 2023, which is herein incorporated by reference in its entirety.

### TECHNICAL FIELD

This disclosure describes a set of advanced video/streaming coding/decoding technologies. More specifically, the disclosed technology involves temporal resampling and restoration.

### BACKGROUND

Uncompressed digital video can include a series of pictures, and may specific bitrate requirements for storage, data processing, and for transmission bandwidth in streaming applications. One purpose of video coding and decoding can be the reduction of redundancy in the uncompressed input video signal, through various compression techniques.

### SUMMARY

The present disclosure describes various embodiments of methods, apparatus, and computer-readable storage medium for improvement of temporal resampling and restoration in video coding and/or decoding systems.

According to one aspect, an embodiment of the present disclosure provides a method for decoding a coded video bitstream. The method includes receiving, by a device, a coded video bitstream. The device includes a memory storing instructions and a processor in communication with the memory. The method also includes extracting, by the device from the coded video bitstream, a syntax indicating a temporal restoration mode, wherein the syntax comprises: a flag and an index, the flag indicating whether temporal restoration is enabled, the index indicating one temporal resampling ratio out of 2\hat{ }N non-unity temporal resampling ratios, wherein the index has N bits, or an index only, the index indicating whether the temporal restoration is enabled and one temporal resampling ratio of at least one temporal resampling ratios; and when the temporal restoration is enabled, restoring, by the device, reconstructed frames to obtain restored frames based on the indicated temporal resampling ratio.

According to another aspect, an embodiment of the present disclosure provides an apparatus for processing a coded video bitstream. The apparatus includes a memory storing instructions; and a processor in communication with the memory. When the processor executes the instructions, the processor is configured to cause the apparatus to perform the above methods for video decoding and/or encoding.

In another aspect, an embodiment of the present disclosure provides non-transitory computer-readable mediums storing instructions which when executed by a computer for video decoding and/or encoding cause the computer to perform the above methods for video decoding and/or encoding.

The above and other aspects and their implementations are described in greater detail in the drawings, the descriptions, and the claims.

### BRIEF DESCRIPTION OF THE DRAWINGS

Further features, the nature, and various advantages of the disclosed subject matter will be more apparent from the following detailed description and the accompanying drawings in which:

FIG. 1 shows a schematic illustration of a simplified block diagram of a communication system (100) in accordance with an example embodiment;

FIG. 2 shows a schematic illustration of a simplified block diagram of a communication system (200) in accordance with an example embodiment;

FIG. 3 shows a schematic illustration of a simplified block diagram of a video decoder in accordance with an example embodiment;

FIG. 4 shows a schematic illustration of a simplified block diagram of a video encoder in accordance with an example embodiment;

FIG. 5 shows a block diagram of a video encoder in accordance with another example embodiment;

FIG. 6 shows a block diagram of a video decoder in accordance with another example embodiment;

FIG. 7 shows a scheme of temporal resampling-based video compression framework according to example embodiments of the disclosure;

FIG. 8 shows a schematic diagram of temporal downsampling according to example embodiments of the disclosure;

FIG. 9 shows a schematic diagram of temporal upsampling according to example embodiments of the disclosure;

FIG. 10 shows an example logic flow for a method in the present disclosure;

FIG. 11 shows an example of a syntax table according to example embodiments of the disclosure;

FIG. 12 shows another example of a syntax table according to example embodiments of the disclosure;

FIG. 13 shows another example of a syntax table according to example embodiments of the disclosure;

FIG. 14 shows another example of a syntax table according to example embodiments of the disclosure; and

FIG. 15 shows a schematic illustration of a computer system in accordance with example embodiments of this disclosure.

### DETAILED DESCRIPTION OF EMBODIMENTS

The invention will now be described in detail hereinafter with reference to the accompanied drawings, which form a part of the present invention, and which show, by way of illustration, specific examples of embodiments. Please note that the invention may, however, be embodied in a variety of different forms and, therefore, the covered or claimed subject matter is intended to be construed as not being limited to any of the embodiments to be set forth below. Please also note that the invention may be embodied as methods, devices, components, or systems. Accordingly, embodiments of the invention may, for example, take the form of hardware, software, firmware or any combination thereof.

Throughout the specification and claims, terms may have nuanced meanings suggested or implied in context beyond an explicitly stated meaning. The phrase “in one embodiment” or “in some embodiments” as used herein does not necessarily refer to the same embodiment and the phrase “in another embodiment” or “in other embodiments” as used herein does not necessarily refer to a different embodiment. Likewise, the phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

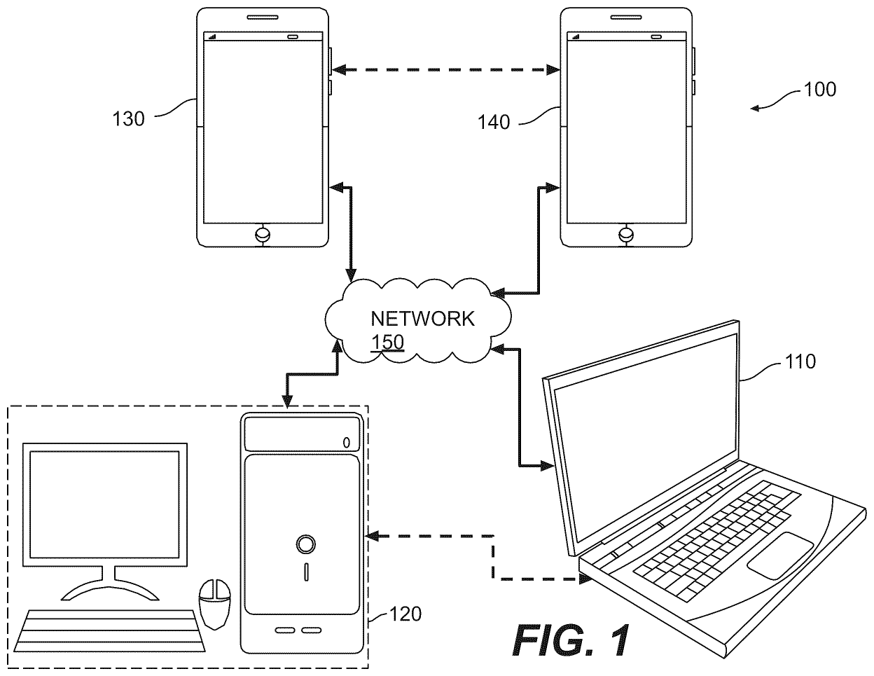

As shown in FIG. 1, terminal devices may be implemented as servers, personal computers and smart phones but the applicability of the underlying principles of the present disclosure may not be so limited. Embodiments of the present disclosure may be implemented in desktop computers, laptop computers, tablet computers, media players, wearable computers, dedicated video conferencing equipment, and/or the like. The network (150) represents any number or types of networks that convey coded video data among the terminal devices, including for example wireline (wired) and/or wireless communication networks. The communication network (150) may exchange data in circuit-switched, packet-switched, and/or other types of channels. Representative networks include telecommunications networks, local area networks, wide area networks and/or the Internet.

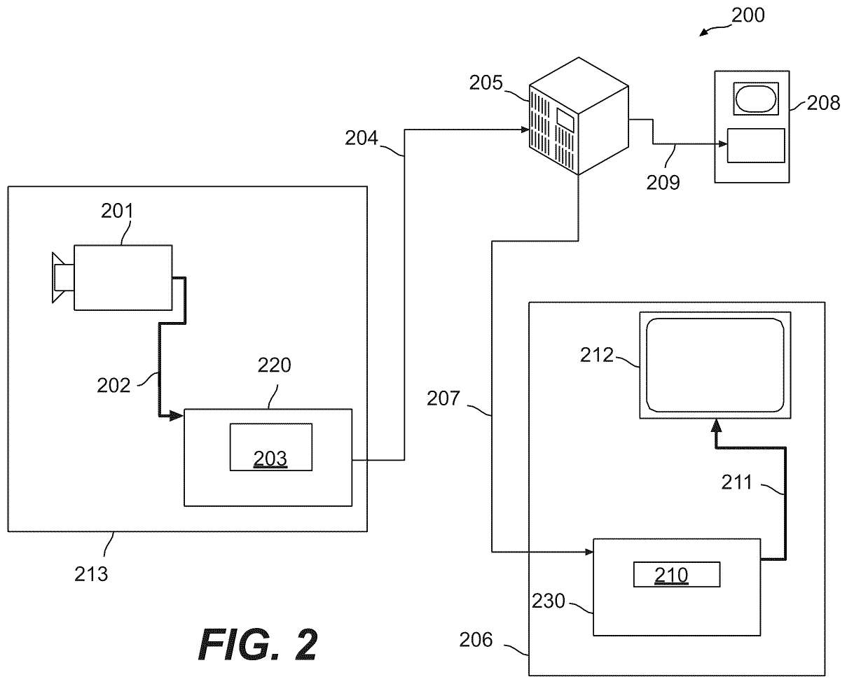

FIG. 2 illustrates, as an example for an application for the disclosed subject matter, a placement of a video encoder and a video decoder in a video streaming environment. The disclosed subject matter may be equally applicable to other video applications, including, for example, video conferencing, digital TV broadcasting, gaming, virtual reality, storage of compressed video on digital media including CD, DVD, memory stick and the like, and so on.

As shown in FIG. 2, a video streaming system may include a video capture subsystem (213) that can include a video source (201), e.g., a digital camera, for creating a stream of video pictures or images (202) that are uncompressed. In an example, the stream of video pictures (202) includes samples that are recorded by a digital camera of the video source (201). The stream of video pictures (202), depicted as a bold line to emphasize a high data volume when compared to encoded video data (204) (or coded video bitstreams), can be processed by an electronic device (220) that includes a video encoder (203) coupled to the video source (201). The video encoder (203) can include hardware, software, or a combination thereof to enable or implement aspects of the disclosed subject matter as described in more detail below. The encoded video data (204) (or encoded video bitstream (204)), depicted as a thin line to emphasize a lower data volume when compared to the stream of uncompressed video pictures (202), can be stored on a streaming server (205) for future use or directly to downstream video devices (not shown). One or more streaming client subsystems, such as client subsystems (206) and (208) in FIG. 2 can access the streaming server (205) to retrieve copies (207) and (209) of the encoded video data (204). A client subsystem (206) can include a video decoder (210), for example, in an electronic device (230). The video decoder (210) decodes the incoming copy (207) of the encoded video data and creates an outgoing stream of video pictures (211) that are uncompressed and that can be rendered on a display (212) (e.g., a display screen) or other rendering devices (not depicted).

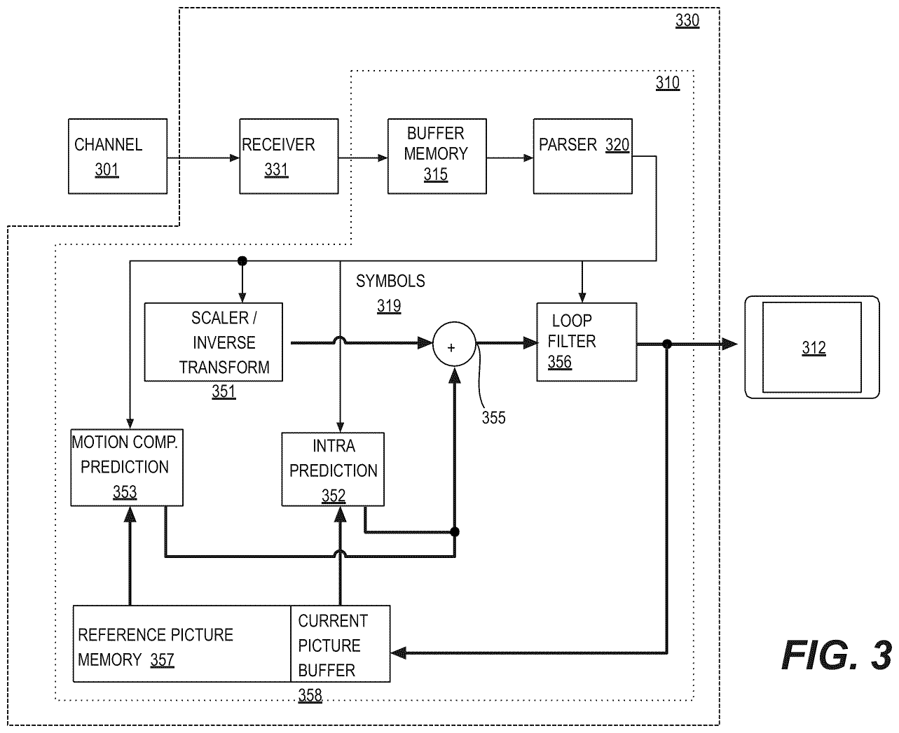

FIG. 3 shows a block diagram of a video decoder (310) of an electronic device (330) according to any embodiment of the present disclosure below. The electronic device (330) can include a receiver (331) (e.g., receiving circuitry). The video decoder (310) can be used in place of the video decoder (210) in the example of FIG. 2.

As shown, in FIG., 3, the receiver (331) may receive one or more coded video sequences from a channel (301). To combat network jitter and/or handle playback timing, a buffer memory (315) may be disposed in between the receiver (331) and an entropy decoder/parser (320) (“parser (320)” henceforth). The parser (320) may reconstruct symbols (321) from the coded video sequence. Categories of those symbols include information used to manage operation of the video decoder (310), and potentially information to control a rendering device such as display (312) (e.g., a display screen). The parser (320) may parse/entropy-decode the coded video sequence. The parser (320) may extract from the coded video sequence, a set of subgroup parameters for at least one of the subgroups of pixels in the video decoder. The subgroups can include Groups of Pictures (GOPs), pictures, tiles, slices, macroblocks, Coding Units (CUs), blocks, Transform Units (TUs), Prediction Units (PUs) and so forth. The parser (320) may also extract from the coded video sequence information such as transform coefficients (e.g., Fourier transform coefficients), quantizer parameter values, motion vectors, and so forth. Reconstruction of the symbols (321) can involve multiple different processing or functional units. The units that are involved and how they are involved may be controlled by the subgroup control information that was parsed from the coded video sequence by the parser (320).

A first unit may include the scaler/inverse transform unit (351). The scaler/inverse transform unit (351) may receive a quantized transform coefficient as well as control information, including information indicating which type of inverse transform to use, block size, quantization factor/parameters, quantization scaling matrices, and the lie as symbol(s) (321) from the parser (320). The scaler/inverse transform unit (351) can output blocks comprising sample values that can be input into aggregator (355).

In some cases, the output samples of the scaler/inverse transform (351) can pertain to an intra coded block, i.e., a block that does not use predictive information from previously reconstructed pictures, but can use predictive information from previously reconstructed parts of the current picture. Such predictive information can be provided by an intra picture prediction unit (352). In some cases, the intra picture prediction unit (352) may generate a block of the same size and shape of the block under reconstruction using surrounding block information that is already reconstructed and stored in the current picture buffer (358). The current picture buffer (358) buffers, for example, partly reconstructed current picture and/or fully reconstructed current picture. The aggregator (355), in some implementations, may add, on a per sample basis, the prediction information the intra prediction unit (352) has generated to the output sample information as provided by the scaler/inverse transform unit (351).

In other cases, the output samples of the scaler/inverse transform unit (351) can pertain to an inter coded, and potentially motion compensated block. In such a case, a motion compensation prediction unit (353) can access reference picture memory (357) based on motion vector to fetch samples used for inter-picture prediction. After motion compensating the fetched reference samples in accordance with the symbols (321) pertaining to the block, these samples can be added by the aggregator (355) to the output of the scaler/inverse transform unit (351) (output of unit 351 may be referred to as the residual samples or residual signal) so as to generate output sample information.

The output samples of the aggregator (355) can be subject to various loop filtering techniques in the loop filter unit (356) including several types of loop filters. The output of the loop filter unit (356) can be a sample stream that can be output to the rendering device (312) as well as stored in the reference picture memory (357) for use in future inter-picture prediction.

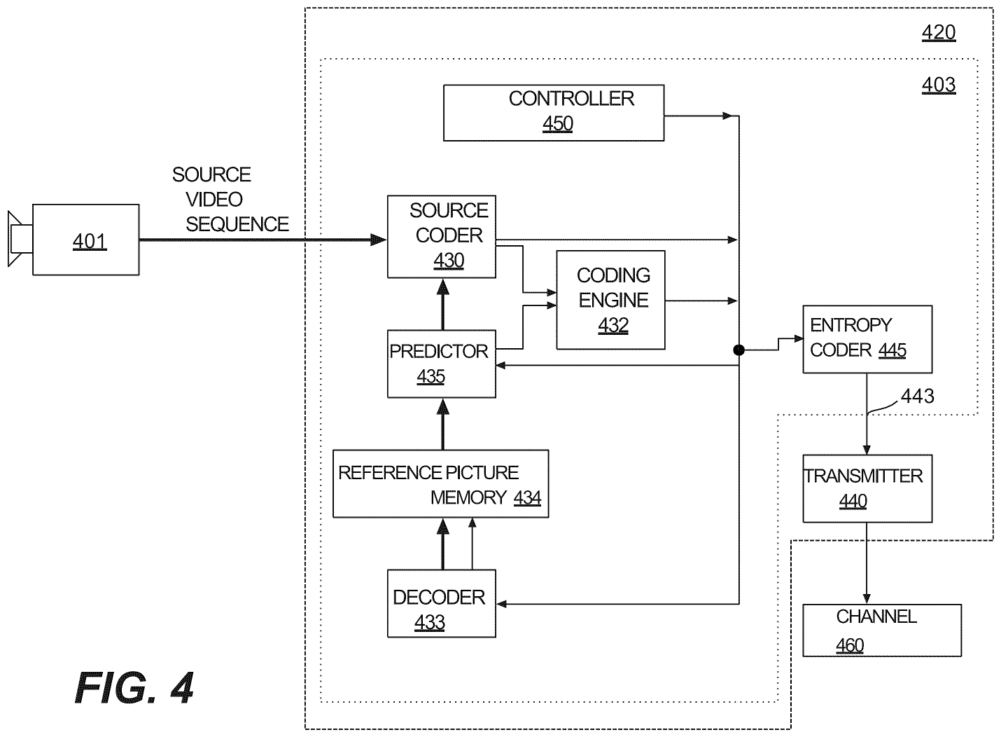

FIG. 4 shows a block diagram of a video encoder (403) according to an example embodiment of the present disclosure. The video encoder (403) may be included in an electronic device (420). The electronic device (420) may further include a transmitter (440) (e.g., transmitting circuitry). The video encoder (403) can be used in place of the video encoder (403) in the example of FIG. 4.

The video encoder (403) may receive video samples from a video source (401). According to some example embodiments, the video encoder (403) may code and compress the pictures of the source video sequence into a coded video sequence (443) in real time or under any other time constraints as required by the application. Enforcing appropriate coding speed constitutes one function of a controller (450). In some embodiments, the controller (450) may be functionally coupled to and control other functional units as described below. Parameters set by the controller (450) can include rate control related parameters (picture skip, quantizer, lambda value of rate-distortion optimization techniques, . . . ), picture size, group of pictures (GOP) layout, maximum motion vector search range, and the like.

In some example embodiments, the video encoder (403) may be configured to operate in a coding loop. The coding loop can include a source coder (430), and a (local) decoder (433) embedded in the video encoder (403). The decoder (433) reconstructs the symbols to create the sample data in a similar manner as a (remote) decoder would create even though the embedded decoder 433 process coded video steam by the source coder 430 without entropy coding (as any compression between symbols and coded video bitstream in entropy coding may be lossless in the video compression technologies considered in the disclosed subject matter). An observation that can be made at this point is that any decoder technology except the parsing/entropy decoding that may only be present in a decoder also may necessarily need to be present, in substantially identical functional form, in a corresponding encoder. For this reason, the disclosed subject matter may at times focus on decoder operation, which allies to the decoding portion of the encoder. The description of encoder technologies can thus be abbreviated as they are the inverse of the comprehensively described decoder technologies. Only in certain areas or aspects a more detail description of the encoder is provided below.

During operation in some example implementations, the source coder (430) may perform motion compensated predictive coding, which codes an input picture predictively with reference to one or more previously coded picture from the video sequence that were designated as “reference pictures.”

The local video decoder (433) may decode coded video data of pictures that may be designated as reference pictures. The local video decoder (433) replicates decoding processes that may be performed by the video decoder on reference pictures and may cause reconstructed reference pictures to be stored in a reference picture cache (434). In this manner, the video encoder (403) may store copies of reconstructed reference pictures locally that have common content as the reconstructed reference pictures that will be obtained by a far-end (remote) video decoder (absent transmission errors).

The predictor (435) may perform prediction searches for the coding engine (432). That is, for a new picture to be coded, the predictor (435) may search the reference picture memory (434) for sample data (as candidate reference pixel blocks) or certain metadata such as reference picture motion vectors, block shapes, and so on, that may serve as an appropriate prediction reference for the new pictures.

The controller (450) may manage coding operations of the source coder (430), including, for example, setting of parameters and subgroup parameters used for encoding the video data.

Output of all aforementioned functional units may be subjected to entropy coding in the entropy coder (445). The transmitter (440) may buffer the coded video sequence(s) as created by the entropy coder (445) to prepare for transmission via a communication channel (460), which may be a hardware/software link to a storage device which would store the encoded video data. The transmitter (440) may merge coded video data from the video coder (403) with other data to be transmitted, for example, coded audio data and/or ancillary data streams (sources not shown).

The controller (450) may manage operation of the video encoder (403). During coding, the controller (450) may assign to each coded picture a certain coded picture type, which may affect the coding techniques that may be applied to the respective picture. For example, pictures often may be assigned as one of the following picture types: an Intra Picture (I picture), a predictive picture (P picture), a bi-directionally predictive picture (B Picture), a multiple-predictive picture. Source pictures commonly may be subdivided spatially into a plurality of sample coding blocks as described in further detail below.

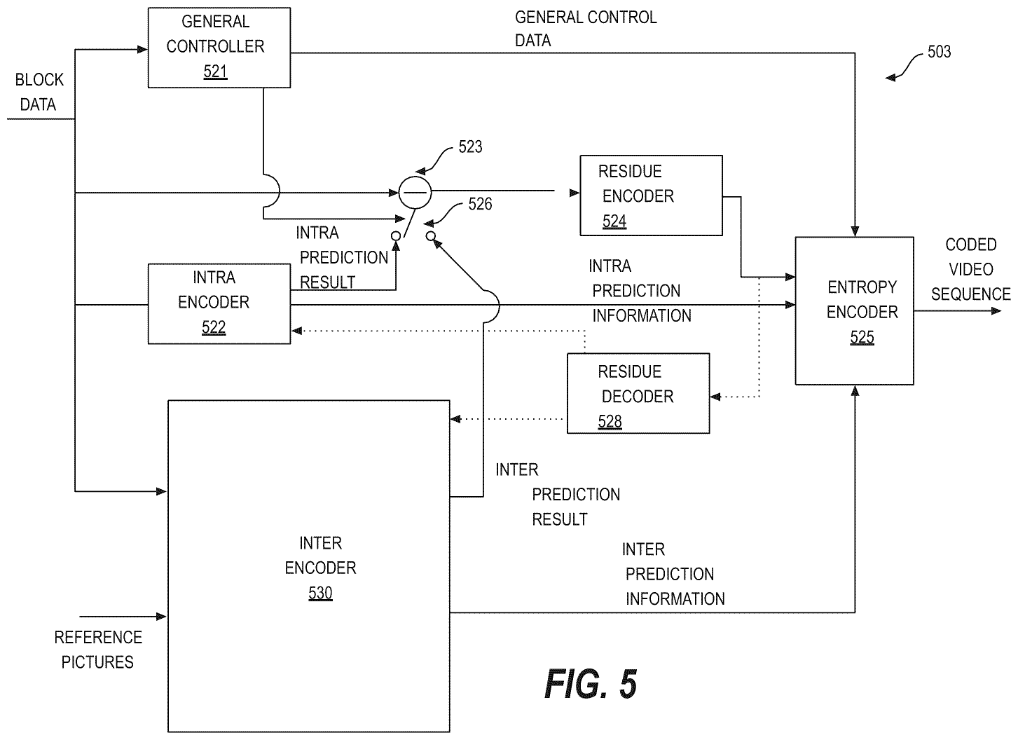

FIG. 5 shows a diagram of a video encoder (503) according to another example embodiment of the disclosure. The video encoder (503) is configured to receive a processing block (e.g., a prediction block) of sample values within a current video picture in a sequence of video pictures, and encode the processing block into a coded picture that is part of a coded video sequence. The example video encoder (503) may be used in place of the video encoder (403) in the FIG. 4 example.

For example, the video encoder (503) receives a matrix of sample values for a processing block. The video encoder (503) then determines whether the processing block is best coded using intra mode, inter mode, or bi-prediction mode using, for example, rate-distortion optimization (RDO).

In the example of FIG. 5, the video encoder (503) includes an inter encoder (530), an intra encoder (522), a residue calculator (523), a switch (526), a residue encoder (524), a general controller (521), and an entropy encoder (525) coupled together as shown in the example arrangement in FIG. 5.

The inter encoder (530) is configured to receive the samples of the current block (e.g., a processing block), compare the block to one or more reference blocks in reference pictures (e.g., blocks in previous pictures and later pictures in display order), generate inter prediction information (e.g., description of redundant information according to inter encoding technique, motion vectors, merge mode information), and calculate inter prediction results (e.g., predicted block) based on the inter prediction information using any suitable technique.

The intra encoder (522) is configured to receive the samples of the current block (e.g., a processing block), compare the block to blocks already coded in the same picture, and generate quantized coefficients after transform, and in some cases also to generate intra prediction information (e.g., an intra prediction direction information according to one or more intra encoding techniques).

The general controller (521) may be configured to determine general control data and control other components of the video encoder (503) based on the general control data to, for example, determine the prediction mode of the block and provides a control signal to the switch (526) based on the prediction mode.

The residue calculator (523) may be configured to calculate a difference (residue data) between the received block and prediction results for the block selected from the intra encoder (522) or the inter encoder (530). The residue encoder (524) may be configured to encode the residue data to generate transform coefficients. The transform coefficients are then subject to quantization processing to obtain quantized transform coefficients. In various example embodiments, the video encoder (503) also includes a residual decoder (528). The residual decoder (528) is configured to perform inverse-transform, and generate the decoded residue data. The entropy encoder (525) may be configured to format the bitstream to include the encoded block and perform entropy coding.

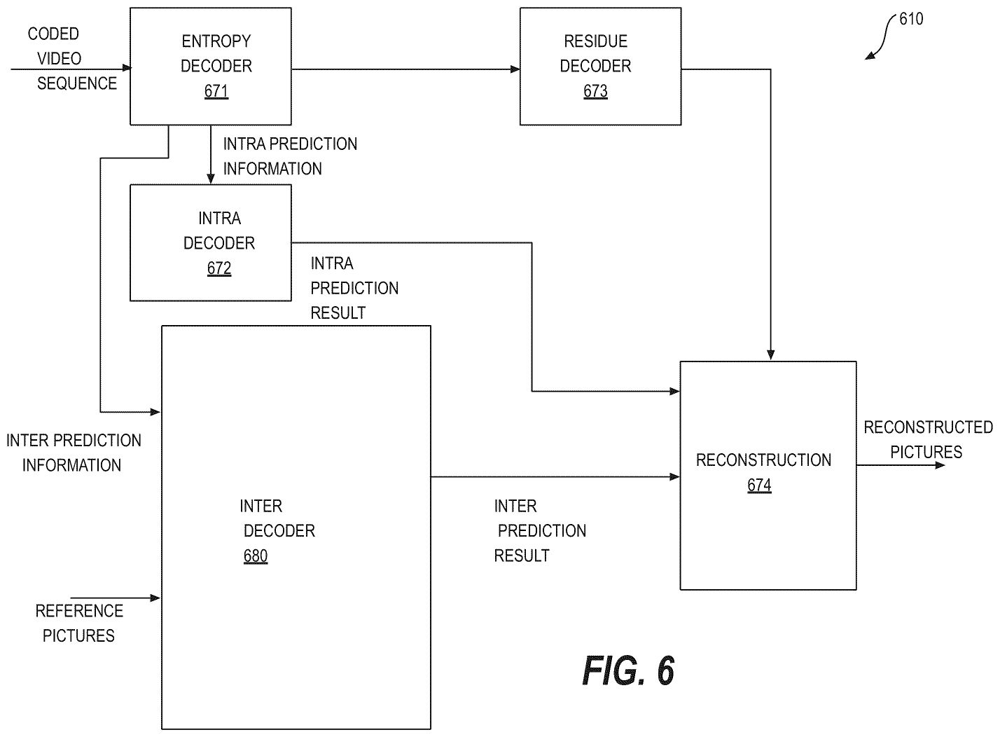

FIG. 6 shows a diagram of an example video decoder (610) according to another embodiment of the disclosure. The video decoder (610) is configured to receive coded pictures that are part of a coded video sequence, and decode the coded pictures to generate reconstructed pictures. In an example, the video decoder (610) may be used in place of the video decoder (410) in the example of FIG. 4.

In the example of FIG. 6, the video decoder (610) includes an entropy decoder (671), an inter decoder (680), a residual decoder (673), a reconstruction module (674), and an intra decoder (672) coupled together as shown in the example arrangement of FIG. 6.

The entropy decoder (671) can be configured to reconstruct, from the coded picture, certain symbols that represent the syntax elements of which the coded picture is made up. The inter decoder (680) may be configured to receive the inter prediction information, and generate inter prediction results based on the inter prediction information. The intra decoder (672) may be configured to receive the intra prediction information, and generate prediction results based on the intra prediction information. The residual decoder (673) may be configured to perform inverse quantization to extract de-quantized transform coefficients, and process the de-quantized transform coefficients to convert the residual from the frequency domain to the spatial domain. The reconstruction module (674) may be configured to combine, in the spatial domain, the residual as output by the residual decoder (673) and the prediction results (as output by the inter or intra prediction modules as the case may be) to form a reconstructed block forming part of the reconstructed picture as part of the reconstructed video.

It is noted that the video encoders (203), (403), and (503), and the video decoders (210), (310), and (610) can be implemented using any suitable technique. In some example embodiments, the video encoders (203), (403), and (503), and the video decoders (210), (310), and (610) can be implemented using one or more integrated circuits. In another embodiment, the video encoders (203), (403), and (503), and the video decoders (210), (310), and (610) can be implemented using one or more processors that execute software instructions.

Turning to block partitioning for coding and decoding, general partitioning may start from a base block and may follow a predefined ruleset, particular patterns, partition trees, or any partition structure or scheme. The partitioning may be hierarchical and recursive. After dividing or partitioning a base block following any of the example partitioning procedures or other procedures described below, or the combination thereof, a final set of partitions or coding blocks may be obtained. Each of these partitions may be at one of various partitioning levels in the partitioning hierarchy, and may be of various shapes. Each of the partitions may be referred to as a coding block (CB). For the various example partitioning implementations described further below, each resulting CB may be of any of the allowed sizes and partitioning levels. Such partitions are referred to as coding blocks because they may form units for which some basic coding/decoding decisions may be made and coding/decoding parameters may be optimized, determined, and signaled in an encoded video bitstream. The highest or deepest level in the final partitions represents the depth of the coding block partitioning structure of tree. A coding block may be a luma coding block or a chroma coding block. The CB tree structure of each color may be referred to as coding block tree (CBT). The coding blocks of all color channels may collectively be referred to as a coding unit (CU). The hierarchical structure of for all color channels may be collectively referred to as coding tree unit (CTU). The partitioning patterns or structures for the various color channels in in a CTU may or may not be the same.

In some implementations, partition tree schemes or structures used for the luma and chroma channels may not need to be the same. In other words, luma and chroma channels may have separate coding tree structures or patterns. Further, whether the luma and chroma channels use the same or different coding partition tree structures and the actual coding partition tree structures to be used may depend on whether the slice being coded is a P, B, or I slice. For example, For an I slice, the chroma channels and luma channel may have separate coding partition tree structures or coding partition tree structure modes, whereas for a P or B slice, the luma and chroma channels may share a same coding partition tree scheme. When separate coding partition tree structures or modes are applied, a luma channel may be partitioned into CBs by one coding partition tree structure, and a chroma channel may be partitioned into chroma CBs by another coding partition tree structure.

In some other example implementations for coding block partitioning, a quadtree structure may be used. Such quadtree splitting may be applied hierarchically and recursively to any square shaped partitions. Whether a base block or an intermediate block or partition is further quadtree split may be adapted to various local characteristics of the base block or intermediate block/partition.

In yet some other examples, a ternary partitioning scheme may be used for partitioning a base block or any intermediate block. The ternary pattern may be implemented vertical or horizontal. The above partitioning schemes may be combined in any manner at different partitioning levels. As one example, the quadtree and the binary partitioning schemes described above may be combined to partition a base block into a quadtree-binary-tree (QTBT) structure. In such a scheme, a base block or an intermediate block/partition may be either quadtree split or binary split, subject to a set of predefined conditions, if specified.

In some implementations, a set of intra prediction modes (interchangeably referred to as “intra modes”) may include a predefined number of directional intra prediction modes. These intra prediction modes may correspond to a predefined number of directions along which out-of-block samples are selected as prediction for samples being predicted in a particular block. In another particular example implementation, eight (8) main directional modes corresponding to angles from 45 to 207 degrees to the horizontal axis may be supported and predefined. In some other implementations of intra prediction, to further exploit more varieties of spatial redundancy in directional textures, directional intra modes may be further extended to an angle set with finer granularity. For example, the 8-angle implementation above may be configured to provide eight nominal angles, referred to as V_PRED, H_PRED, D45_PRED, D135_PRED, D113_PRED, D157_PRED, D203_PRED, and D67_PRED, and for each nominal angle, a predefined number (e.g., 7) of finer angles may be added. With such an extension, a larger total number (e.g., 56) of directional angles may be available for intra prediction, corresponding to the same number of predefined directional intra modes. A prediction angle may be represented by a nominal intra angle plus an angle delta. For the particular example above with 7 finer angular directions for each nominal angle, the angle delta may be ˜3˜3 multiplies a step size of 3 degrees. In some implementations, 8 nominal modes together with 5 non-angular smooth modes are firstly signaled, then if current mode is angular mode, an index is further signaled to indicate the angle delta to the corresponding nominal angle. In some implementations, to implement directional prediction modes via a generic way, all the 56 directional intra prediction mode may be implemented with a unified directional predictor that projects each pixel to a reference sub-pixel location and interpolates the reference pixel by a 2-tap bilinear filter.

Transform of a residual of either an intra prediction block or an inter prediction block may then be implemented followed by quantization of the transform coefficient. For the purpose of performing transform, both intra and inter coded blocks may be further partitioned into multiple transform blocks (sometimes interchangeably used as “transform units”, even though the term “unit” is normally used to represent a congregation of the three-color channels, e.g., a “coding unit” would include luma coding block, and chroma coding blocks) prior to the transform. In some implementations, the maximum partitioning depth of the coded blocks (or prediction blocks) may be specified (the term “coded blocks” may be used interchangeably with “coding blocks”). For example, such partitioning may not go beyond 2 levels. The division of prediction block into transform blocks may be handled differently between intra prediction blocks and inter prediction blocks. In some implementations, however, such division may be similar between intra prediction blocks and inter prediction blocks.

In some example implementations, and for inter coded blocks, the transform unit partitioning may be done in a recursive manner with the partitioning depth up to a predefined number of levels (e.g., 2 levels). Split may stop or continue recursively for any sub partition and at any level. For example, one block is split into four quadtree sub blocks and one of the subblocks is further split into four second level transform blocks whereas division of the other subblocks stops after the first level, yielding a total of 7 transform blocks of two different sizes. In some implementations, the transform partitioning may support 1:1 (square), 1:2/2:1, and 1:4/4:1 transform block shapes and sizes ranging from 4×4 to 64×64. In some example implementations, if the coding block is smaller than or equal to 64×64, the transform block partitioning may only be applied to luma component (in other words, the chroma transform block would be the same as the coding block under that condition). Otherwise, if the coding block width or height is greater than 64, both the luma and chroma coding blocks may be implicitly split into multiples of min (W, 64)×min (H, 64) and min (W, 32)×min (H, 32) transform blocks, respectively.

The present disclosure describes various embodiments for temporal resampling and restoration mode representation, signaling, coding, and parsing in video coding and/or decoding systems. The embodiments of this application can be applied to cloud technology, smart transportation, assisted driving, and other scenarios involving machine recognition and/or for machine consumption. In some implementations, various methods in the present disclosure may be applicable for video coding for machines (CVM).

In some implementations, the machine recognition scene may include the scene in which the machine interprets the video data and completes related tasks (such as detection, recognition, and other tasks). For example, the video perception features of the target user for video data in the user viewing scenario are different from those of the target machine in the machine recognition scenario. Therefore, the requirements for the quality and resolution of video data in the user viewing scenario are different from those in the machine recognition scenario. The encoding device can also obtain the video content features of the original video data, which may include the rate of change of the video content in the original video data, the amount of video content information, the video resolution of the video frames in the original video data, and the number of video frames played per unit time in the original video data.

In some implementations, the quality requirements of the video data may depend on media application scenario, for example, content change rate requirements and resolution requirements. In some implementations, video content characteristics of the original video data may indicate the video content change rate, and an encoding device can determine the target sampling parameters for sampling and processing the original video data according to the media application scenario and the characteristics of the video content. The sampling parameters can include the sampling mode and the sampling ratio in the sampling mode. Specifically, the target sampling mode may include whether a temporal sampling mode is enabled or not, and/or whether a spatial sampling mode is enabled or not. The temporal sampling mode refers to sampling video frames (related to frame rate), and the spatial sampling mode refers to sampling pixels/lines/blocks in each frame (related to frame resolution). For example, the sampling ratio in the temporal sampling mode may be 2 (i.e., sampling each of every other frames), or 3 (i.e., sampling each of every 3 frames); and the sampling rate in spatial sampling mode may be any value greater than 0, such as 0.5 (i.e., resolution being 0.5 times of its original resolution), or 0.75 (i.e., resolution being 0.75 times of its original resolution), or 2× (i.e., resolution being 2 times of its original resolution).

In some implementations, the sampling parameters (mode and/or ratio/rate) may be determined according to the characteristics of the video content and/or specific scenario. In some implementations, the video-perceptual features may be determined for the video data in the media application scenario, and/or based on the perceptual features of the video and the characteristics of the video content, the sampling ratio/rate under the target sampling mode is determined. The target sampling ratio/rate and target sampling method are determined as the target sampling parameters used for sampling and processing the original video data.

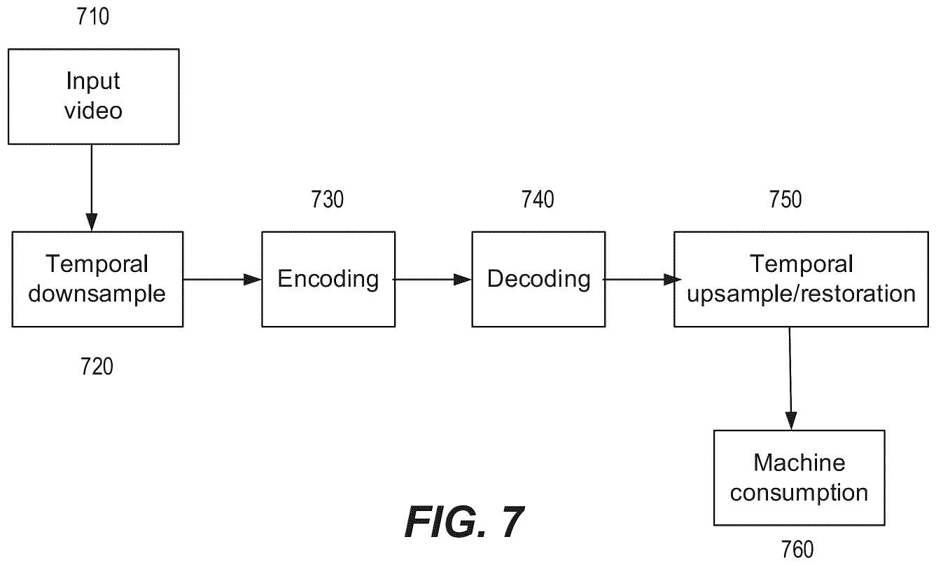

FIG. 7 shows an exemplary embodiment of a temporal resampling-based video data processing pipeline, which may include a portion or all of the following: temporal downsampling 720, encoding 730, decoding 740, and/or temporal upsampling (or referred as temporal restoration) 750. An input video 710 may be temporally downsampled before encoding, and then downsampled video data may be fed into the encoder to be compressed in video bitstream for transmission, storage, or other processing. In some implementations, the transmitted or retrieved compressed video bitstream is decoded for reconstructing video sequence; and the reconstructed video sequence is further temporally upsampled (e.g., to its original frame rate or a different frame rate) for further processing (e.g., for machine consumption 760). Some implementations may not include the temporal upsampling unit, wherein the reconstructed video sequence from the decoder is ready directly for application (e.g., for machine consumption).

In some implementations, an encoding device (e.g., encoder) can sample (e.g., downsample) original video data according to sampling parameters (e.g., the sampling mode and the sampling ratio) to obtain the downsampled video data. The downsampled video data is subsequently encoded to obtain the video coding data corresponding to the original video data. Thus, the data volume of the video coding data can be reduced, and the transmission efficiency of the video coding data can be improved, and the storage space of the video coding data is reduced simultaneously. In some implementations, a decoding device (e.g., decoder) can upsample the reconstructed video data, for example, with the same sampling ratio, so that a same frame rate may be achieved with upsampling.

FIG. 8 shows several non-limiting examples of performing temporal downsampling, wherein the original video is downsampled in temporal domain by resampling the video frames with equal interval: temporal downsampling ratios (or rates) may include 2 (810), 3 (820), or 4 (830). In some implementations, the temporal downsampling ratio (or rate) may be any positive integer larger than 1. In some other implementations, the temporal downsampling ratio (or rate) may be any positive integer including 1, wherein a value of 1 indicates there is no temporal sampling.

Considering an original video with POC of {0, 1, 2, 3, 4, 5, 6, 7, 8, . . . } and the downsampling ratio being 2, the framerate is reduced to the half size of original framerate with remaining POC {0, 2, 4, 6, 8, . . . }, and the frame with POC {1, 3, 5, 7, . . . } are dropped. Considering the downsampling ratio being 3, the framerate is reduced to a third size of original framerate with remaining POC {0, 3, 6, 9, . . . }, and the frame with POC {1, 2, 4, 5, 7, 8, . . . } are dropped. Considering the downsampling ratio being 4, the framerate is reduced to a fourth size of original framerate with remaining POC {0, 4, 8, . . . }, and the frame with POC {1, 2, 3, 5, 6, 7, . . . } are dropped.

The information about the temporal sampling mode and/or the temporal sampling ratio is contained in the video bitstream and is signaled to the decoder for upsampling (restoration) purpose.

In various embodiments on the decoding side, when the information signed in the bitstream indicates that the decoded video has been downsampled in temporal domain, an decoder is configured to perform the temporal upsampling after the video is reconstructed to recover the original frame rate.

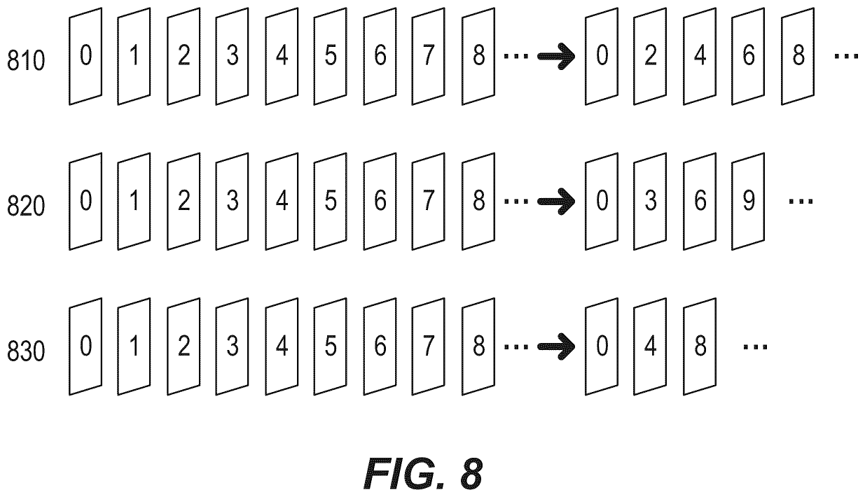

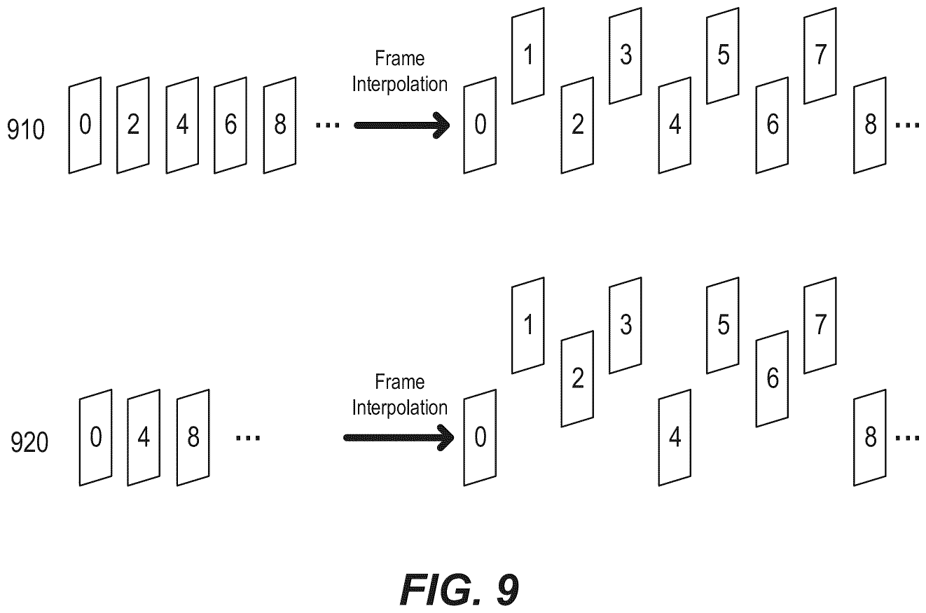

FIG. 9 shows several non-limiting examples of performing temporal upsampling, wherein the upsampling may be performed by frame interpolation according to temporal upsampling ratios (or rates), which is equal to temporal downsampling ratios (rates) including 2 (910), or 4 (920). In some implementations, the temporal upsampling ratio (rate) may be different from the temporal downsampling ratio (rate).

For example, in the 2× resampling ratio case, the dropped frames are interpolated by the previous and the following frames. For 4× resampling ratio, the dropped frames are interpolated in a hierarchical way. For example, at the first step the POC 2 frame is generated by POC 0 and POC 4. Then the frames of POC 1 and POC 3 are interpolated by the generated POC 2 and POC 0 and POC 4 subsequently. In some implementations, when the frame number of the interpolated video is smaller than the original frame number obtained from the bitstream, this temporal upsampling module duplicates the last frame to match the original frame rate.

In some implementations, an optical-flow-based video frame interpolation network is used for the temporal domain up-sampling. The reconstructed frames and their corresponding quantization parameter (QP) maps may be fed into a three-level hierarchical structure to extract features in different granularities. An additional module (e.g., omniscient video super-resolution (OVSR)) may be employed to further explore the relationship of the features in the lowest level. Besides, an intermediate feature refine network (IFRNet) may be employed to estimate the optical flows among the intermediate frame and the two input frames. The estimated optical flows may be also downsampled via bilinear method into the similar pyramid structure as the extracted features. The three levels of feature and optical-flows are synthetized by backward warping and optical-flow-based calculation. Finally, a set of networks (e.g, GridNet and/or residual block (ResBlock)) may output the generated reference frame with the synthetized features as input.

Various embodiments and/or implementations described in the present disclosure may be performed separately or combined in any order, and may be applicable for decoding, encoding, or streaming. Further, each of the methods (or embodiments), encoder, and decoder may be implemented by processing circuitry (e.g., one or more processors or one or more integrated circuits). The one or more processors execute a program that is stored in a non-transitory computer-readable medium.

The present disclosure describes various embodiments including methods to signal, code, deliver and/or parse temporal resampling and restoration modes and related information including enabling flag, resampling ratio, etc. in video coding and/or decoding systems. Various embodiments in the present disclosure may be used for not only human but also machine consumptions, for example for Video Coding for Machines (VCM) scenarios as well as in general video coding/decoding systems.

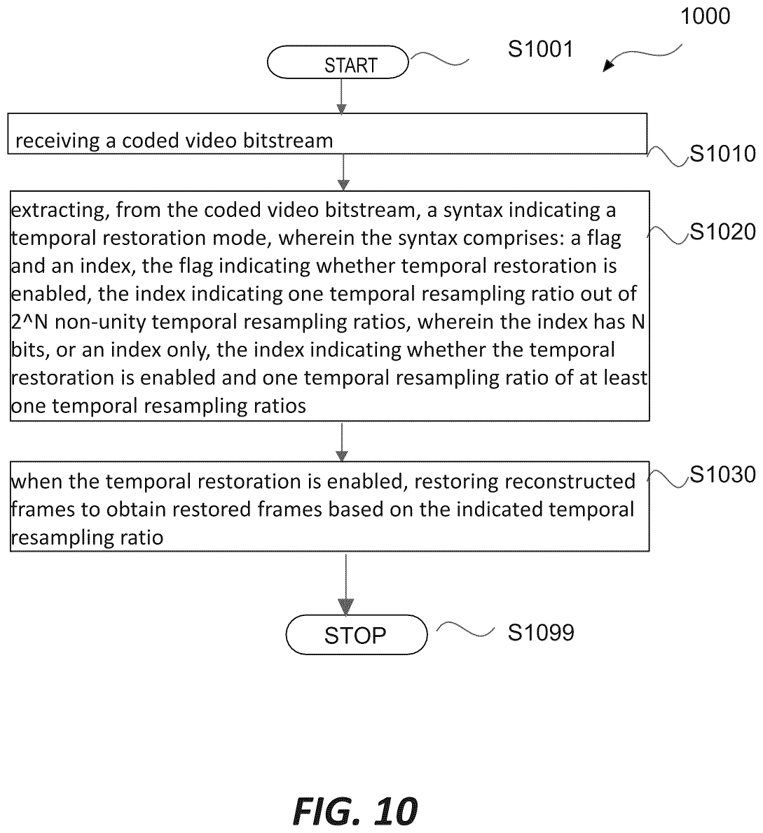

FIG. 10 shows a flow chart 1000 of an exemplary method following the principles underlying the implementations above. The exemplary decoding method flow starts at 1001, and may include a portion or all of the following steps: S1010, receiving the coded video bitstream; S1020, extracting, from the coded video bitstream, a syntax indicating a temporal restoration mode, wherein the syntax comprises: a flag and an index, the flag indicating whether temporal restoration is enabled, the index indicating one temporal resampling ratio out of 2\hat{ }N non-unity temporal resampling ratios, wherein the index has N bits, or an index only, the index indicating whether the temporal restoration is enabled and one temporal resampling ratio of at least one temporal resampling ratios; and/or S1030 when the temporal restoration is enabled, restoring reconstructed frames to obtain restored frames based on the indicated temporal resampling ratio. The example method stops at S1099. The method 1000 may be preformed by a device comprising a memory storing instructions and a processor in communication with the memory.

In various embodiments in the present disclosure, whether a temporal restoration is enabled (applied) may refer to whether the decoder (or encoder) need to upsample (or downsample, respectively) the received video frames, as described in various embodiments and/or implementations in the present disclosure.

In various embodiments in the present disclosure, a temporal resampling ratio may refer to a portion or all of the following: a temporal upsampling ratio (rate), a temporal downsampling ratio (or rate), and/or a temporal sampling ratio (rate), as described in various embodiments and/or implementations in the present disclosure. In some implementations, the temporal resampling ratio is an integer larger than 1.

In various embodiments in the present disclosure, a temporal restoration mode may refer to a portion or all of the following: temporal sampling information, temporal downsampling information, and/or temporal resampling information, as described in various embodiments and/or implementations in the present disclosure. For example, the temporal restoration model may include whether the temporal restoration is enabled (applied) or disabled (not applied), and the temporal resampling ratio when the temporal restoration is enabled (applied). For example, one temporal restoration mode may include that the temporal restoration is disabled (not applied); another temporal restoration mode may include that the temporal restoration is enabled (applied) and the temporal resampling ratio is 4.

In some implementations, in addition to any portion or combination of the embodiments and/or implementations in the present disclosure, the method may include reconstructing the reconstructed frames based on the coded video bitstream; and/or the method may include outputting the restored frames for machine consumption.

In some implementations, in addition to any portion or combination of the embodiments and/or implementations in the present disclosure, the restoring reconstructed frames to obtain restored frames based on the indicated temporal resampling ratio may include performing frame interpolation to generate frames to be included with the reconstructed frames, so as to upsample the reconstructed frames.

In some implementations, in addition to any portion or combination of the embodiments and/or implementations in the present disclosure, when the syntax comprises the flag and the index: when the flag is “1”, the flag indicates that the temporal restoration is enabled; and/or when the flag is “0”, the flag indicates that the temporal restoration is disabled. In some other implementations, when the flag is “0”, the flag indicates that the temporal restoration is enabled; and/or when the flag is “1”, the flag indicates that the temporal restoration is disabled.

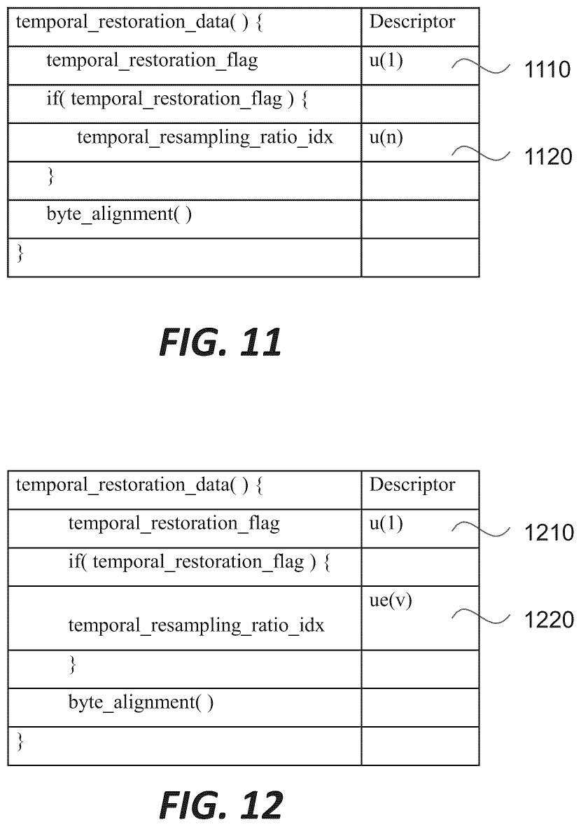

Referring to FIG. 11, the syntax may include the temporal_restoration_flag 1110 (i.e., the flag) and temporal_resampling_ratio_idx 1120 (i.e., the index). In some implementations, when the flag indicates that the temporal restoration is disabled, the syntax may not include the temporal_resampling_ratio_idx, so as to reduce signaling bits to improve video coding efficiency.

In some implementations, in addition to any portion or combination of the embodiments and/or implementations in the present disclosure, when the syntax comprises the flag and the index: the temporal resampling ratio is indicated by the index by: being equal to (M+1) or 2\hat{ }(M+1), wherein M is an unsigned integer value of the index.

Referring to FIG. 11, the index (temporal_resampling_ratio_idx) is n-bit unsigned integer with values (M) that can range from 0 to 2\hat{ }n−1. In some implementations, this corresponds to the resampling and restoration ratios from 2 to 2\hat{ }n+1. For example, when the descriptor of the temporal_resampling_ratio_idx is u(2) (i.e., n=2), the temporal_resampling_ratio_idx equals to one of 0, 1, 2, or 3, which indicates the temporal resampling and restoration ratio to be one of 2, 3, 4, or 5, respectively. In some implementations, this corresponds to the resampling and restoration ratios from 2 to 2\hat{ }(2\hat{ }n), i.e., 2, 4, 8, 16, . . . , 2\hat{ }(2\hat{ }n)). For example, when the descriptor of the temporal_resampling_ratio_idx is u(2) (i.e., n=2),

the temporal_resampling_ratio_idx equals to one of 0, 1, 2, or 3, which specifies the temporal resampling and restoration ratio to be equal to one of 2, 4, 8, or 16, respectively. For another example, when the descriptor of the temporal_resampling_ratio_idx is u(1) (i.e., n=1), the temporal_resampling_ratio_idx equals to one of 0 or 1, which specifies the temporal resampling and restoration ratio to be equal to one of 2 or 4, respectively.

In some implementations, in addition to any portion or combination of the embodiments and/or implementations in the present disclosure, the syntax comprises the flag and the index: the temporal resampling ratio is indicated by the index by: the index indicating an entry value in a look-up table, wherein the look-up table comprises 2\hat{ }N non-unity temporal resampling ratios from 2 to (2\hat{ }N+1) or from 2 to 2\hat{ }(N+1).

Referring to FIG. 12, the syntax may include the temporal_restoration_flag 1210 (i.e., the flag) and temporal_resampling_ratio_idx 1220 (i.e., the index). In some implementations, when the flag indicates that the temporal restoration is disabled, the syntax may not include the temporal_resampling_ratio_idx, so as to reduce signaling bits to improve video coding efficiency.

Tables 1-3 show non-limiting examples of look-up tables including temporal resampling ratios, wherein the temporal_resampling_ratio_idx equals to one of k codeword, which specifies the temporal resampling and restoration ratio to be equal to n. In some implementations, the binary 0 and 1 in the codewords in the tables may be flipped.

Table 1 shows temporal resampling ratios increasing from 2 to higher positive integer linearly and sequentially. In some implementations, the maximum length of the ue(v) codeword may be pre-defined. For example, when it is pre-defined to be equal to 2 or 3, the maximum temporal resampling and restoration ratio n are 4 and 6, respectively.

Table 2 shows temporal resampling ratios increasing from 2 to higher positive integer exponentially. In some implementations, the maximum length of the ue(v) codeword may be pre-defined. For example, when it is pre-defined to be equal to 2 or 3, the maximum temporal resampling and restoration ratio n are 8 and 32, respectively.

Table 3 shows a non-limiting look-up table with temporal resampling ratios increasing from 2 to higher positive integer not in pure exponential and not in pure linear fashion. In some implementations, the temporal resampling ratios (n) in the look-up table may be one part being linear and another part being exponential, and combinations of any other number series.

TABLE 1
Example look-up table including temporal resampling ratios

| k (ue(v) codeword) | n |
|---|---|
| 0 | 2 |
| 10 | 3 |
| 11 | 4 |
| 110 | 5 |
| 111 | 6 |
| . . . | . . . |

TABLE 2
Example look-up table including temporal resampling ratios

| k (ue(v) codeword) | n |
|---|---|
| 0 | 2 |
| 10 | 4 |
| 11 | 8 |
| 110 | 16 |
| 111 | 32 |
| . . . | . . . |

TABLE 3
Example look-up table including temporal resampling ratios

| k (ue(v) codeword) | n |
|---|---|
| 0 | 2 |
| 10 | 3 |
| 11 | 4 |
| 110 | 8 |
| 111 | 16 |
| . . . | . . . |

In some implementations, in addition to any portion or combination of the embodiments and/or implementations in the present disclosure, when the syntax comprises the index only: when the index is zero, the temporal restoration is disabled; when the index is larger than zero, the temporal restoration is enabled, and the temporal resampling ratio is (M+1) or 2\hat{ }(M+1), wherein M is an unsigned integer value of the index.

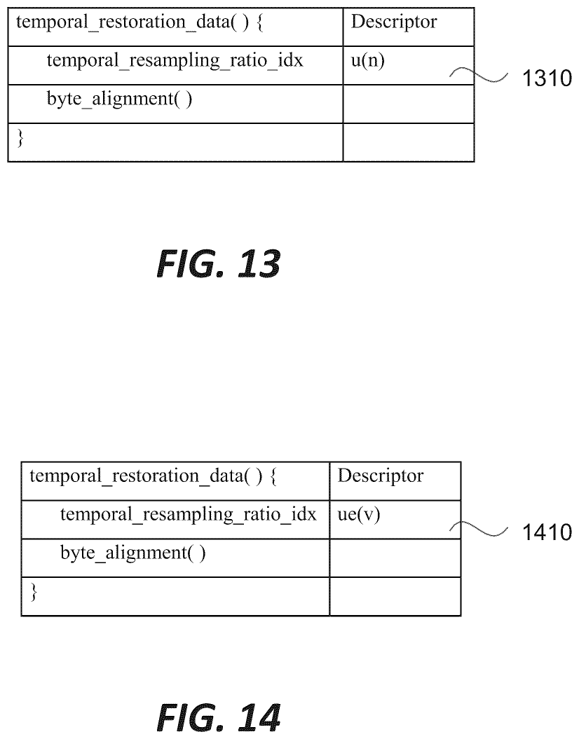

Referring to FIG. 13, the syntax may include the temporal_resampling_ratio_idx 1310 (i.e., the index) without any flag. The temporal_resampling_ratio_idx is n-bit unsigned integer with values that can range from 0 to 2\hat{ }n−1. In some implementations, the temporal_resampling_ratio_idx may specifies the temporal resampling and restoration ratio to be equal to i+1, where i is the value of temporal_resampling_ratio_idx. Except when i is 0, where it specifies that temporal resampling and restoration are not applied.

For example, when the descriptor of temporal_resampling_ratio_idx is u(2), the temporal_resampling_ratio_idx equals to one of 0, 1, 2, or 3. When the temporal_resampling_ratio_idx equals to 0, it indicates that the temporal resampling and restoration are not applied. When the temporal_resampling_ratio_idx equals to 1, 2, or 3, it specifies the temporal resampling and restoration ratio to be equal to 2, 3, or 4, respectively.

In some implementations, in addition to any portion or combination of the embodiments and/or implementations in the present disclosure, when the syntax comprises the index only: the index indicates an entry value in a look-up table, wherein the look-up tables comprises values from 1 to (2\hat{ }N−1) or from 1 to 2\hat{ }(M−1); when the entry value is “1”, the temporal restoration is disabled; and/or when the entry value is larger than 1, the temporal restoration is enabled, and the temporal resampling ratio is the entry value, wherein M is an unsigned integer value of the index.

Referring to FIG. 14, the syntax may include the temporal_resampling_ratio_idx 1410 (i.e., the index) without any flag. The temporal_resampling_ratio_idx equal to k specifies the temporal resampling and restoration ratio to be equal n, described in a look-up table (e.g., Tables 4-6).

Tables 4-6 show non-limiting examples of look-up tables including temporal resampling ratios, wherein the temporal_resampling_ratio_idx equals to one of k codeword, which specifies the temporal resampling and restoration ratio to be equal to n. In some implementations, the binary 0 and 1 in the codewords in the tables may be flipped.

Table 4 shows temporal resampling ratios increasing from 1 to higher positive integer linearly and sequentially. In some implementations, when temporal_resampling_ratio_idx (n) is equal to 0, it is equivalent to temporal resampling and restoration are not applied. In some implementations, the maximum length of the ue(v) codeword may be pre-defined. For example, when it is pre-defined to be equal to 2 or 3, then the maximum temporal resampling ratio n are 3 and 5, respectively.

Table 5 shows temporal resampling ratios increasing from 1 to higher positive integer exponentially. In some implementations, when temporal_resampling_ratio_idx (n) is equal to 1, it is equivalent to temporal resampling and restoration are not applied. In some implementations, the maximum length of the ue(v) codeword may be pre-defined. For example, when it is pre-defined to be equal to 2 or 3, the maximum temporal resampling ratio n are 4 and 16, respectively.

Table 6 shows a non-limiting look-up table with temporal resampling ratios increasing from 1 to higher positive integer not in pure exponential and not in pure linear fashion. In some implementations, the temporal resampling ratios (n) in the look-up table may be one part being linear and another part being exponential, and combinations of any other number series.

TABLE 4
Example look-up table including temporal resampling ratios

| k (ue(v) codeword) | n |
|---|---|
| 0 | 1 |
| 10 | 2 |
| 11 | 3 |
| 110 | 4 |
| 111 | 5 |
| . . . | . . . |

TABLE 5
Example look-up table including temporal resampling ratios

| k (ue(v) codeword) | n |
|---|---|
| 0 | 1 |
| 10 | 2 |
| 11 | 4 |
| 110 | 8 |
| 111 | 16 |
| . . . | . . . |

TABLE 6
Example look-up table including temporal resampling ratios

| k (ue(v) codeword) | n |
|---|---|
| 0 | 1 |
| 10 | 2 |
| 11 | 3 |
| 110 | 4 |
| 111 | 8 |
| . . . | . . . |

Various embodiments in the present disclosure may include methods for downsampling a video bitstream, which are performed by an encoder, including inverse processes as any portion or all of the processes that are described for the decoder.

Various embodiments in the present disclosure may include methods for encoding and/or decoding a streaming video, which are performed by one or more electronic device (e.g., streaming media player), including any portion or all of the processes for the decoder and/or any portion or all of the processes that are described for an encoder.

Operations above may be combined or arranged in any amount or order, as desired. Two or more of the steps and/or operations may be performed in parallel. Embodiments and implementations in the disclosure may be used separately or combined in any order. Further, each of the methods (or embodiments), an encoder, and a decoder may be implemented by processing circuitry (e.g., one or more processors or one or more integrated circuits). In one example, the one or more processors execute a program that is stored in a non-transitory computer-readable medium. Embodiments in the disclosure may be applied to a luma block or a chroma block. The term block may be interpreted as a prediction block, a coding block, or a coding unit, i.e. CU. The term block here may also be used to refer to the transform block. In the following items, when saying block size, it may refer to either the block width or height, or maximum value of width and height, or minimum of width and height, or area size (width*height), or aspect ratio (width:height, or height:width) of the block.

The techniques described above, can be implemented as computer software using computer-readable instructions and physically stored in one or more computer-readable media.

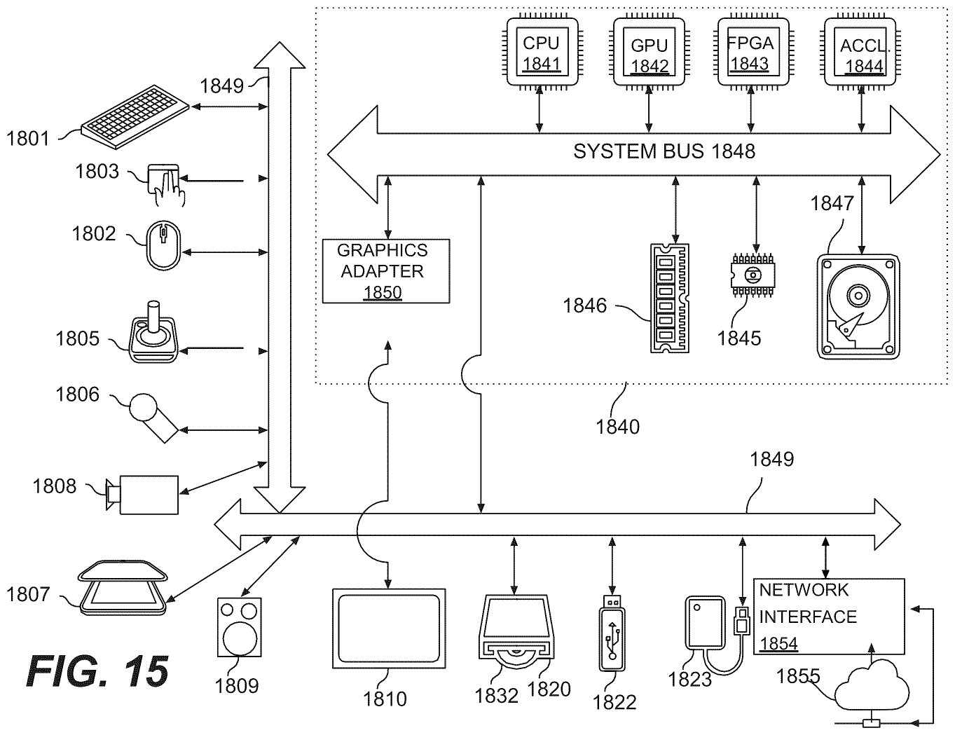

For example, FIG. 15 shows a computer system (1800) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 15 for computer system (1800) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1800).

Computer system (1800) may include certain human interface input devices. Input human interface devices may include one or more of (only one of each depicted): keyboard (1801), mouse (1802), trackpad (1803), touch screen (1810), data-glove (not shown), joystick (1805), microphone (1806), scanner (1807), camera (1808).

Computer system (1800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1810), data-glove (not shown), or joystick (1805), but there can also be tactile feedback devices that do not serve as input devices), audio output devices (such as: speakers (1809), headphones (not depicted)), visual output devices (such as screens (1810) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1800) can also include human accessible storage devices and their associated media such as optical media including CD/DVD ROM/RW (1820) with CD/DVD or the like media (1821), thumb-drive (1822), removable hard drive or solid state drive (1823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1800) can also include an interface (1854) to one or more communication networks (1855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CAN bus, and so forth.

Aforementioned human interface devices, human-accessible storage devices, and network interfaces can be attached to a core (1840) of the computer system (1800).

The core (1840) can include one or more Central Processing Units (CPU) (1841), Graphics Processing Units (GPU) (1842), specialized programmable processing units in the form of Field Programmable Gate Areas (FPGA) (1843), hardware accelerators for certain tasks (1844), graphics adapters (1850), and so forth. These devices, along with Read-only memory (ROM) (1845), Random-access memory (1846), internal mass storage such as internal non-user accessible hard drives, SSDs, and the like (1847), may be connected through a system bus (1848). In some computer systems, the system bus (1848) can be accessible in the form of one or more physical plugs to enable extensions by additional CPUs, GPU, and the like. The peripheral devices can be attached either directly to the core's system bus (1848), or through a peripheral bus (1849). In an example, the screen (1810) can be connected to the graphics adapter (1850). Architectures for a peripheral bus include PCI, USB, and the like.

The computer readable media can have computer code thereon for performing various computer-implemented operations. The media and computer code can be those specially designed and constructed for the purposes of the present disclosure, or they can be of the kind well known and available to those having skill in the computer software arts.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for decoding a coded video bitstream, the method comprising:
receiving, by a device comprising a memory storing instructions and a processor in communication with the memory, a coded video bitstream;
extracting, by the device from the coded video bitstream, a syntax indicating a temporal restoration mode, wherein the syntax comprises:
a flag and an index, the flag indicating whether temporal restoration is enabled, the index indicating one temporal resampling ratio out of 2\hat{ }N non-unity temporal resampling ratios, wherein the index has N bits, or
an index only, the index indicating whether the temporal restoration is enabled and one temporal resampling ratio of at least one temporal resampling ratios; and
when the temporal restoration is enabled, restoring, by the device, reconstructed frames to obtain restored frames based on the indicated temporal resampling ratio.

2. The method according to claim 1, wherein the restoring reconstructed frames to obtain restored frames based on the indicated temporal resampling ratio comprises:
performing, based on the indicated temporal resampling ratio, frame interpolation based on the reconstructed frames to generate frames to be added with the reconstructed frames to obtain the restored frames.

3. The method according to claim 1, wherein, when the syntax comprises the flag and the index:
when the flag is “1”, the flag indicates that the temporal restoration is enabled; and
when the flag is “0”, the flag indicates that the temporal restoration is disabled.

4. The method according to claim 1, wherein, when the syntax comprises the flag and the index:
the temporal resampling ratio is indicated by the index by:
being equal to (M+2) or 2\hat{ }(M+1), wherein M is an unsigned integer value of the index.

5. The method according to claim 1, wherein, when the syntax comprises the flag and the index:
the temporal resampling ratio is indicated by the index by:
the index indicating an entry value in a look-up table, wherein the look-up table comprises 2\hat{ }N non-unity temporal resampling ratios from 2 to (2\hat{ }N+1) or from 2 to 2\hat{ }(N+1).

6. The method according to claim 1, wherein, when the syntax comprises the index only:
when the index is zero, the temporal restoration is disabled;
when the index is larger than zero, the temporal restoration is enabled, and the temporal resampling ratio is (M+1) or 2\hat{ }(M+1), wherein M is an unsigned integer value of the index.

7. The method according to claim 1, wherein, when the syntax comprises the index only:
the index indicates an entry value in a look-up table, wherein the look-up tables comprises values from 1 to (2\hat{ }N−1) or from 1 to 2\hat{ }(M−1);
when the entry value is “1”, the temporal restoration is disabled;
when the entry value is larger than 1, the temporal restoration is enabled, and the temporal resampling ratio is the entry value,
wherein M is an unsigned integer value of the index.

8. An apparatus for decoding a current block of a current frame in a coded video bitstream, the apparatus comprising:
a memory storing instructions; and
a processor in communication with the memory, wherein, when the processor executes the instructions, the processor is configured to cause the apparatus to:
receive a coded video bitstream;
extract, from the coded video bitstream, a syntax indicating a temporal restoration mode, wherein the syntax comprises:
a flag and an index, the flag indicating whether temporal restoration is enabled, the index indicating one temporal resampling ratio out of 2\hat{ }N non-unity temporal resampling ratios, wherein the index has N bits, or
an index only, the index indicating whether the temporal restoration is enabled and one temporal resampling ratio of at least one temporal resampling ratios; and
when the temporal restoration is enabled, restore reconstructed frames to obtain restored frames based on the indicated temporal resampling ratio.

9. The apparatus according to claim 8, wherein, when the processor is configured to cause the apparatus to restore reconstructed frames to obtain the restored frames based on the indicated temporal resampling ratio, the processor is configured to cause the apparatus to:
perform, based on the indicated temporal resampling ratio, frame interpolation based on the reconstructed frames to generate frames to be added with the reconstructed frames to obtain the restored frames.

10. The apparatus according to claim 8, wherein, when the syntax comprises the flag and the index:
when the flag is “1”, the flag indicates that the temporal restoration is enabled; and
when the flag is “0”, the flag indicates that the temporal restoration is disabled.

11. The apparatus according to claim 8, wherein, when the syntax comprises the flag and the index:
the temporal resampling ratio is indicated by the index by:
being equal to (M+2) or 2\hat{ }(M+1), wherein M is an unsigned integer value of the index.

12. The apparatus according to claim 8, wherein, when the syntax comprises the flag and the index:
the temporal resampling ratio is indicated by the index by:
the index indicating an entry value in a look-up table, wherein the look-up table comprises 2\hat{ }N non-unity temporal resampling ratios from 2 to (2\hat{ }N+1) or from 2 to 2\hat{ }(N+1).

13. The apparatus according to claim 8, wherein, when the syntax comprises the index only:
when the index is zero, the temporal restoration is disabled;
when the index is larger than zero, the temporal restoration is enabled, and the temporal resampling ratio is (M+1) or 2\hat{ }(M+1), wherein M is an unsigned integer value of the index.

14. The apparatus according to claim 8, wherein, when the syntax comprises the index only:
the index indicates an entry value in a look-up table, wherein the look-up tables comprises values from 1 to (2\hat{ }N−1) or from 1 to 2\hat{ }(M−1);
when the entry value is “1”, the temporal restoration is disabled;
when the entry value is larger than 1, the temporal restoration is enabled, and the temporal resampling ratio is the entry value,
wherein M is an unsigned integer value of the index.

15. A non-transitory computer readable storage medium storing instructions, wherein, when the instructions are executed by a processor, the instructions are configured to cause the processor to:
receive a coded video bitstream;
extract, from the coded video bitstream, a syntax indicating a temporal restoration mode, wherein the syntax comprises:
a flag and an index, the flag indicating whether temporal restoration is enabled, the index indicating one temporal resampling ratio out of 2\hat{ }N non-unity temporal resampling ratios, wherein the index has N bits, or
an index only, the index indicating whether the temporal restoration is enabled and one temporal resampling ratio of at least one temporal resampling ratios; and
when the temporal restoration is enabled, restore reconstructed frames to obtain restored frames based on the indicated temporal resampling ratio.

16. The non-transitory computer readable storage medium according to claim 15, wherein, when the syntax comprises the flag and the index:
when the flag is “1”, the flag indicates that the temporal restoration is enabled; and
when the flag is “0”, the flag indicates that the temporal restoration is disabled.

17. The non-transitory computer readable storage medium according to claim 15, wherein, when the syntax comprises the flag and the index:
the temporal resampling ratio is indicated by the index by:
being equal to (M+2) or 2\hat{ }(M+1), wherein M is an unsigned integer value of the index.

18. The non-transitory computer readable storage medium according to claim 15, wherein, when the syntax comprises the flag and the index:
the temporal resampling ratio is indicated by the index by:
the index indicating an entry value in a look-up table, wherein the look-up table comprises 2\hat{ }N non-unity temporal resampling ratios from 2 to (2\hat{ }N+1) or from 2 to 2\hat{ }(N+1).

19. The non-transitory computer readable storage medium according to claim 15, wherein, when the syntax comprises the index only:
when the index is zero, the temporal restoration is disabled;
when the index is larger than zero, the temporal restoration is enabled, and the temporal resampling ratio is (M+1) or 2\hat{ }(M+1), wherein M is an unsigned integer value of the index.

20. The non-transitory computer readable storage medium according to claim 15, wherein, when the syntax comprises the index only:
the index indicates an entry value in a look-up table, wherein the look-up tables comprises values from 1 to (2\hat{ }N−1) or from 1 to 2\hat{ }(M−1);
when the entry value is “1”, the temporal restoration is disabled;
when the entry value is larger than 1, the temporal restoration is enabled, and the temporal resampling ratio is the entry value,
wherein M is an unsigned integer value of the index.
